(19) United States
(12) Patent Application Publication
(10) Pub. No.: US 2025/0325971 A1
(43) Pub. Date: Oct. 23, 2025

(54) GROUP (VIII) CATALYSTS FOR PRODUCTION OF GREEN HYDROGEN AND FORMIC ACID FROM METHANOL AND ITS MECHANISM THEREOF

(71) Applicant: INDIAN INSTITUTE OF TECHNOLOGY, GUWAHATI, Guwahati (IN)

(72) Inventors: Akshai KUMAR, Guwahati (IN); Eileen YASMIN, Kolkata (IN); Sunil DHOLE, Pune (IN); Tushar WAGH, Pune (IN); Vinay ARORA, Gurugram (IN)

(21) Appl. No.: 18/854,533

(22) PCT Filed: Feb. 16, 2023
(86) PCT No.: PCT/IB2023/051407

§ 371 Date: Oct. 6, 2024

(30) Foreign Application Priority Data
Apr. 6, 2022 (IN) 202231020801

(51) Int. Cl. B01J 31/24; C01B 3/32

(52) U.S. Cl. CPC B01J 31/2404; C01B 3/326; B01J 2531/0244; B01J 2531/821; C01B 2203/0227; C01B 2203/1064; C01B 2203/1223

(57) ABSTRACT

The present invention provides a process for the production of green hydrogen gas as a source of clean energy from methanol in addition to quantitative yields of formic acid, catalyzed by a range of group (VIII) complexes based on variety of ligands. Group (VIII) complexes consists of a series of new pincer ruthenium and related Group (VIII) complexes. All of the catalytic complexes are employed towards catalytic methanol reforming for generation of green hydrogen at relatively ambient conditions (<100° C. and 1 atm). Methanol has been used as an efficient and practical hydrogen storage material. A mechanistic pathway for the reaction has been proposed based on the evidence of NMR studies and formation of intermediate, generates hydrogen gas. Both hydrogen and formic acid have immense market value.

### FIELD OF THE INVENTION

The present invention relates to the field of green energy generation. More particularly, the present invention relates to the generation of green hydrogen gas as a source of clean energy from methanol in addition to quantitative yields of formic acid, catalyzed by a range of group (VIII) complexes based on a variety of ligands.

### BACKGROUND OF THE INVENTION

Green hydrogen is the hydrogen fuel that is created using renewable energy instead of fossil fuels. The rapidly declining cost of renewable energy is one reason for the growing interest in green hydrogen. It has the potential to provide clean power for use in oil refining, ammonia production, steel manufacturing, chemical and fertilizer production, food processing, metallurgy, and more.

Due to the high energy demands of our planet and the rapid rate of fossil fuel depletion, there is a great requirement for the alternative and clean sources of energy which would reduce the global pollution. There arise several limitations among the alternative energy sources explored till date like solar, wind, tidal, nuclear and geothermal. Thus, a realistic alternative would be utilizing a combination of renewable energy sources and fossil fuels, leading to the production and storage of energy via homogenous catalysts.

Several reports have emerged over the last few years on the development of H₂ as a sustainable energy source by utilizing reactions discharging hydrogen gas and developing an efficient storage system as well. Homogenous catalysts, especially the pincer type complexes have been efficient in catalyzing aqueous reforming of methanol.

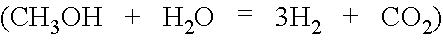

Beller et al. (Nature 2013, 495 (7439), 85-89) discloses the use of Ru complex based on the MACHO ligand to catalyze MeOH/H₂O mixture to H₂ and CO₂ (or CO₃²⁻). In the presence of Ru complex and base, methanol is dehydrogenated to formaldehyde, which is further dehydrogenated to formic acid in presence of water, and at last to carbon dioxide. 3 equivalents of H₂ are evolved in the process, at an ambient temperature of 65-90° C., to result in TON of 353,409 and TOF of 4700 h⁻¹.

Grutzmacher et al. (Nat Chem 2013, 5 (4), 342-7) reported an anionic Ru complex that yielded a lower TOF than the Beller (Nature 2013, 495 (7439), 85-89) but a higher methanol conversion (84% H₂ yield). This reaction was done without the base and the H₂/CO₂ gas mixture evolved was used to power an H₂/O₂ fuel cell. They proceeded to describe the mechanistic details of the reaction involving the complex [Ru(trop2dad)], trop2dad=1,4-bis (5H-dibenzo [a, d]cyclohepten-5-yl)-1,4-diazabuta-1,3-diene) by density function theory based molecular dynamics (DFT-MD) and solvent effects.

Meijer and co-workers (ACS Catal. 2018, 8 (8), 6908-6913) reported the solvent effects of this reaction, pointing to the conclusion that involvement of polar protic solvents largely alters the energetics of the reaction because of hydrogen bonding with the solvent molecules.

Beller et al. (ChemCatChem 2017, 9 (11), 1891-1896) reported that Ir complex binded to a PNP-MACHO ligand gave a lesser TON (1900) as compared to its Ru and Fe counterparts.

Cole-Hamilton et al. (J. Chem. Soc., Chem. Commun. 1987, (4), 248-249) disclosed [Rh(2,2′-bipyridyl)₂]Cl complex to give a TOF of 7 h⁻¹.

Zhan et al. Chin. Chem. Lett. 2017, 28 (7), 1353-1357; relates to [Cp*Rh(NH₃) (H₂O)₂]²⁺ complex which yielded TOF of 83 h⁻¹.

Bernskoetter et al. (ACS Catal. 2015, 5(4), 2404-2415) synthesized a highly active Fe complex that catalyzed methanol reforming in acidic conditions, resulting in 51000 TON. A few 3d metal complexes based on Fe and Mn have also been reported for this reaction.

Beller et al. (Angew. Chem. Int. Ed. 2017, 56 (2), 559-562.) reported a PNP-Mn, the activity of which could be enhanced by addition of excess ligand, and a highest of 20000 TON was achieved.

Some of the previously reported homogenous complexes (base-metal complexes of Fe and Mn) employed towards methanol reforming catalyst are enlisted below:

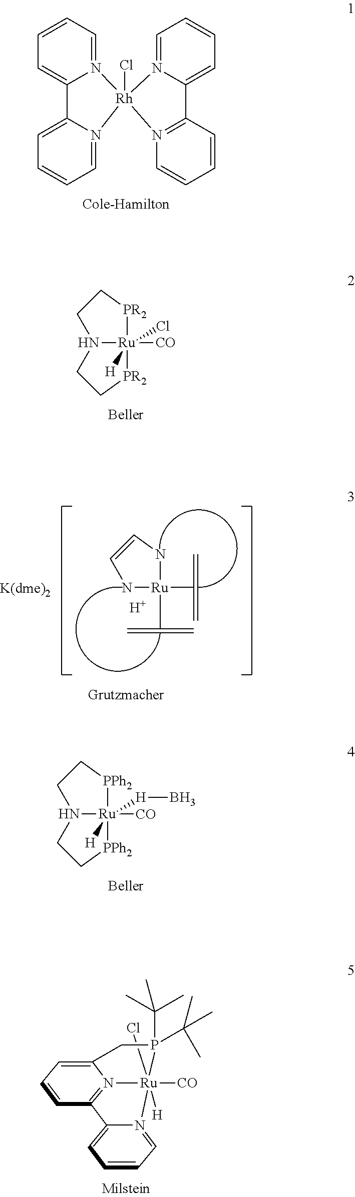

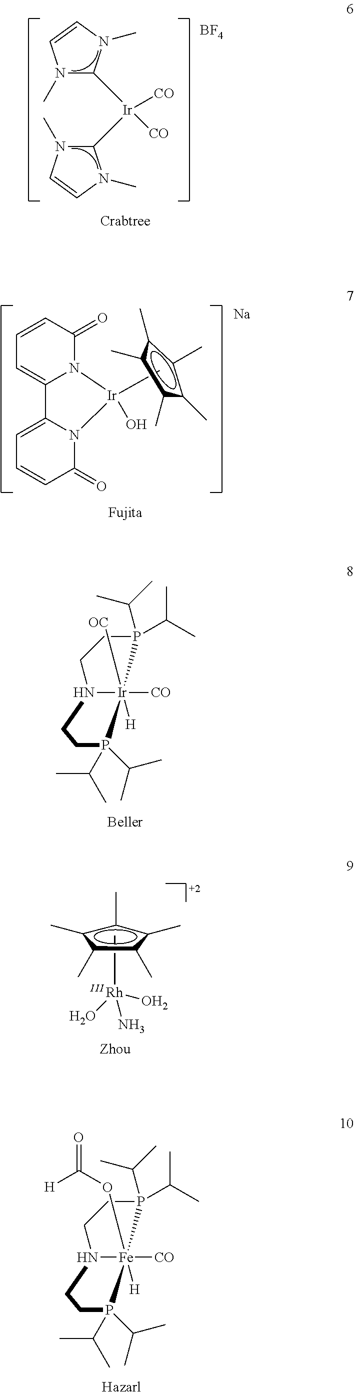

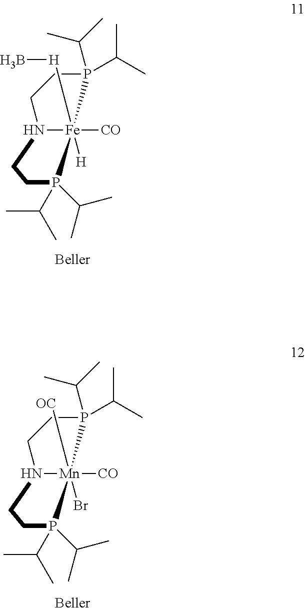

Methanol reforming has been reported by a number of groups by using homogenous pincer complexes, as methanol can be used as an efficient hydrogen storage medium giving high hydrogen conversion and TON (turn over number). The current state of art focuses mainly on methanol reforming to green hydrogen and formic acid at mild conditions.

None of the prior art discloses methanol reforming to green hydrogen and formic acid at ambient conditions. In light of the above, there exists a need to explore a process for synthesizing series of new pincer-ruthenium and related group (VIII) complexes towards catalytic methanol reforming for generation of green hydrogen. The present invention is an endeavor in this direction.

### OBJECT OF THE INVENTION

The main object of the present invention is to provide a process for generation of green hydrogen from methanol.

Another object of the present invention is to provide a process for generation of green hydrogen gas as a source of clean energy from methanol in addition to quantitative yields of formic acid.

Yet another object of the present invention is to provide a process for synthesizing a series of new pincer ruthenium complexes using [Ru(p-cymene) Cl₂]₂ with ^{R2}NNN ligand (R=^{t}Bu, ⁱPr, Cy, Ph).

Yet another object of the present invention is to provide a process for employing pincer ruthenium complexes towards catalytic methanol reforming for generation of green hydrogen.

Yet another object of the present invention is to provide a series of new pincer ruthenium and related group (VIII) complexes for methanol reforming process.

Still, another object of the present invention is to propose a probable group (VIII) catalysts mechanistic pathway for generation of green hydrogen which is used as a clean fuel. Both green hydrogen and formic acid has immense market value.

### SUMMARY OF THE INVENTION

This summary is only intended to provide an introduction of the invention and does not determine the scope of the invention. This summary only introduces the aspects of the invention in a simpler form.

The present invention provides a process for the production of green hydrogen gas as a source of clean energy from methanol in addition to quantitative yields of formic acid, catalyzed by a range of group (VIII) complexes based on variety of ligands.

In an embodiment of the present invention is provided a series of new pincer-ruthenium complexes, synthesized by using [Ru(p-cymene) Cl₂]₂ with ^{R2}NNN ligand (R=^{t}Bu, ⁱPr, Cy, Ph) in presence of CH₃CN as solvent, and all of these complexes were employed towards catalytic methanol reforming for generation of green hydrogen.

In another embodiment of the present invention, is provided a pincer group (VIII) complex catalyst for generation of green hydrogen from methanol reforming, having general formula I:

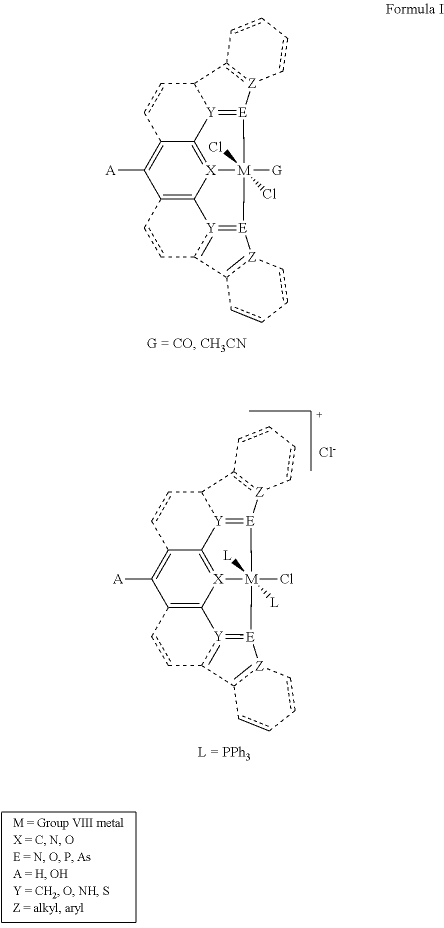

wherein,
M is selected from group VIII elements including iron (Fe), ruthenium (Ru), osmium (Os) and hassium (Hs);
X is selected from carbon, nitrogen or oxygen;
E is nitrogen, oxygen, phosphorus or arsenic;
A is selected from hydrogen or hydroxide;
L is selected from chlorine or triphenylphosphine;
Y is selected from methylene, oxygen, amine group or sulphur; and
Z is selected from alky or aryl group.

In yet another embodiment of the present invention, the series of pincer-ruthenium catalysts is selected from:

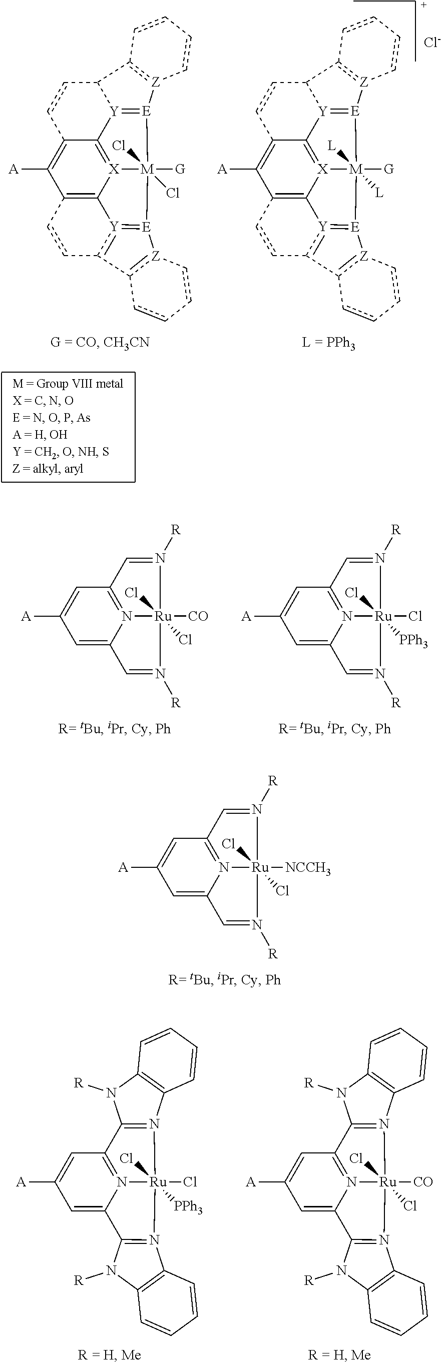

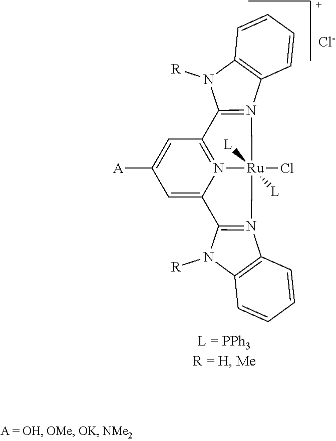

In yet another embodiment of the present invention, a mechanistic pathway for the reaction to generate hydrogen gas is provided.

In yet another embodiment, the process for the production of green hydrogen gas as a source of clean energy comprising the steps of:
a) reacting a catalyst with a base in a reaction vessel to obtain a first reaction mixture;
b) adding 2 equivalents of methanol and 1 equivalent of water to the reaction mixture of step (a) to obtain a second reaction mixture; and
c) heating the second reaction mixture obtained in step (b) at a predetermined temperature for 36-48 hours and measuring the gas evolution.

In still another embodiment of the present invention, said catalyst generates 2 molecules of hydrogen and 1 molecule of formic acid per catalytic reaction.

The above objects and advantages of the present invention will become apparent from the hereinafter set forth brief description of the drawings, detailed description of the invention, and claims appended herewith.

### BRIEF DESCRIPTION OF THE DRAWING

An understanding of the process for the production of green hydrogen from methanol through mechanistic pathway of the present invention may be obtained by reference to the following drawings:

FIG. 1 illustrates a schematic presentation of mechanistic cycle for catalytic methanol reforming according to an embodiment of the present invention.

### DETAILED DESCRIPTION OF THE INVENTION

The present invention now will be described hereinafter with reference to the detailed description, in which some, but not all embodiments of the invention are indicated. Indeed, the invention may be embodied in many different forms and should not be construed as limited to the embodiments set forth herein; rather, these embodiments are provided so that this disclosure will satisfy applicable legal requirements. Like numbers refer to like elements throughout. The present invention is described fully herein with non-limiting embodiments and exemplary experimentation.

The present invention provides a process for the production of green hydrogen gas as a source of clean energy from methanol in addition to quantitative yields of formic acid, catalyzed by a range of group (VIII) complexes based on variety of ligands.

An embodiment of the present invention, provides a mechanistic pathway for the reaction to generate hydrogen gas.

Another embodiment of the present invention, provides a pincer group (VIII) complex catalyst for generation of green hydrogen from methanol reforming, having general formula I:

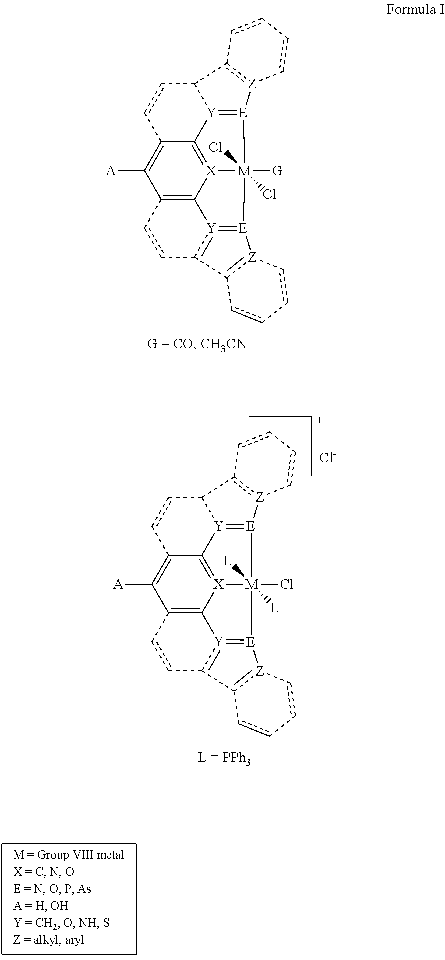

wherein,
M is selected from group VIII elements including iron (Fe), ruthenium (Ru), osmium (Os) and hassium (Hs);
X is selected from carbon, nitrogen or oxygen;
E is nitrogen, oxygen, phosphorus or arsenic;
A is selected from hydrogen or hydroxide;
L is selected from chlorine or triphenylphosphine;
Y is selected from methylene, oxygen, amine group or sulphur; and
Z is selected from alky or aryl group.

Yet another embodiment of the present invention, provides a series of new pincer-ruthenium complexes, synthesized by using [Ru(p-cymene) Cl₂]₂ with ^{R2}NNN ligand (R=^{t}Bu, ⁱPr, Cy, Ph) in presence of CH₃CN as solvent, and all of these complexes were employed towards catalytic methanol reforming for generation of green hydrogen. The proposed catalysts are as follows:

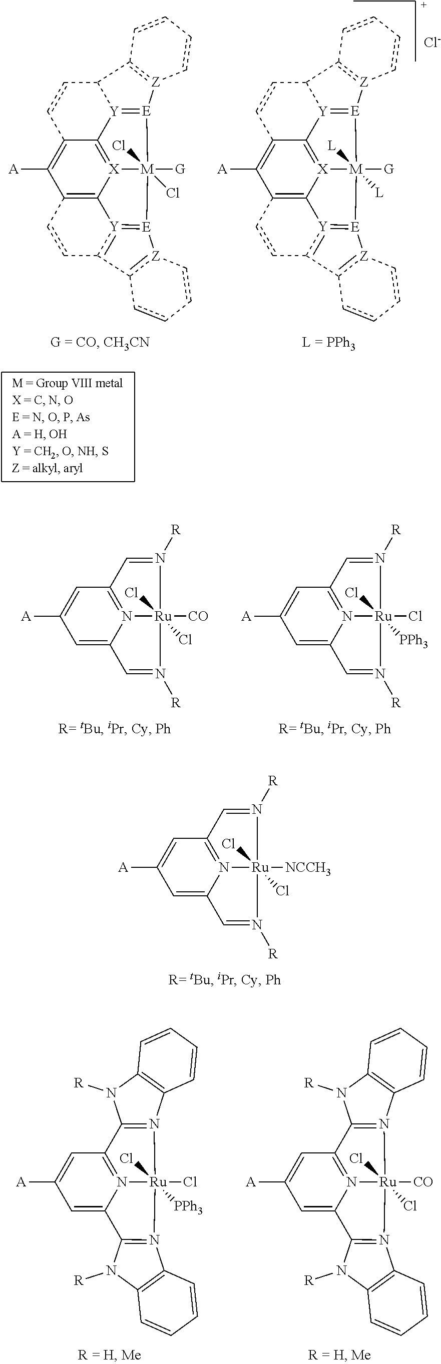

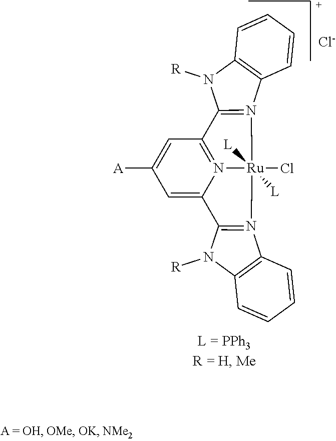

where, R is selected from group of tertiary butyl, isopropyl, cyclohexyl or phenyl.

The pincer ruthenium catalyst are selected, preferably, from;

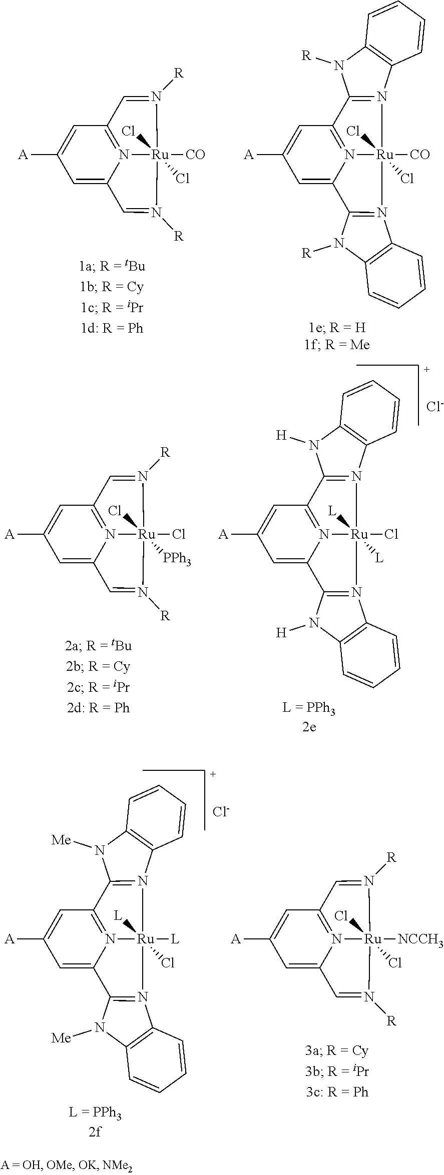

Yet another embodiment of the present invention, provides the process for the production of green hydrogen gas as a source of clean energy comprising the steps of:
a) reacting a catalyst with a base in a reaction vessel to obtain a first reaction mixture;
b) adding 2 equivalent of methanol and 1 equivalent of water to the reaction mixture of step (a) to obtain a second reaction mixture; and
c) heating the second reaction mixture obtained in step (b) at a predetermined temperature for 36-48 hours and measuring the gas evolution.

In yet another embodiment of the present invention, the second reaction mixture is heated at a temperature range of 100-120° C.

In yet another embodiment of the present invention, the amount of catalyst utilized in step (a) ranges from 0.04-2 mol %.

In yet another embodiment of the present invention, the amount of base in in the range of 0.5 to 2 equiv. and is selected from potassium hydroxide, sodium hydroxide, sodium tertiary butoxide, potassium tertiary butoxide, sodium ethoxide, sodium carbonate and potassium carbonate.

In still another embodiment of the present invention, the gas evolution is measured by burette measurements and a single catalytic cycle generates 2 molecules of hydrogen and 1 molecule of formic acid.

$$Conversion = n ( {H}_{2} ) / n ( {H}_{2} O )$$

$$TON = n ( {H}_{2} ) / n ( catalyst )$$

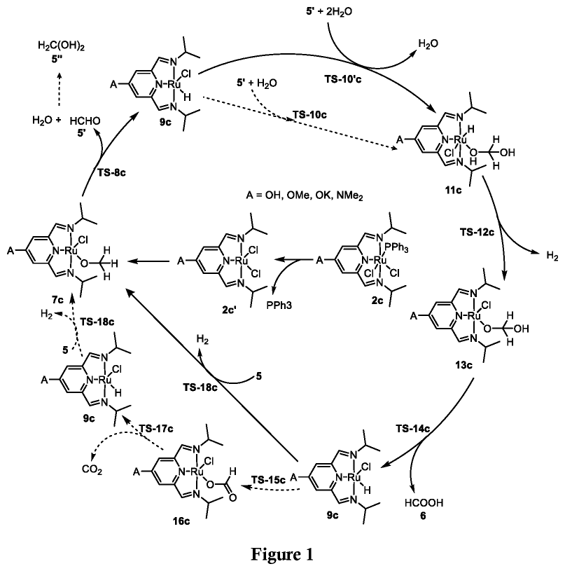

Referring to FIG. 1 of the present invention, a mechanistic pathway for the reaction is shown, based on the evidence of NMR studies and formation of intermediate. The mechanistic pathway is as follows:

The Ru-methoxide intermediate (7c) goes through/3-H elimination to afford formaldehyde (5′) along with the Ru—H species 9c via TS-8c. The overall process is a bit uphill (ΔG₁₀₀=7.56 kcal/mol) with an activation barrier of 17.70 kcal/mol. The formaldehyde (5′) on reaction with water forms methanediol (5″). This step with and without catalyst has a similar energy barrier (32.25 and 33.14 kcal/mol), when formaldehyde (5′) reacts with one water molecule. In presence of an additional water molecule, the barrier without catalyst is 11.77 kcal/mol and the transformation from 9c to 11c via 10c′ is almost barrierless. This can be attributed to the formation of 6-membered transition state with one additional water molecule. Further, σ-bond metathesis of the O—H bond of (5″) coordinated to the metal centre and Ru—H bond in 11c species via TS-12c results in intermediate 13c, with an energy barrier of 23.85 kcal/mol and is an uphill process (ΔG₁₀₀=7.81 kcal/mol). The dehydrogenation of methanediol to formic acid (observed in ¹H NMR) is a downhill process (ΔG₁₀₀=−9.02 kcal/mol) with a barrier ΔG₁₀₀=11.40 kcal/mol (TS-14c). The Ru—H species 9c goes through σ-bond metathesis with methanol to give back Ru-methoxide species 7c via TS-18c (ΔG^{‡}₁₀₀=18.64 kcal/mol) in an uphill process (ΔG₁₀₀=3.10 kcal/mol). The further dehydrogenation of formic acid is tough as it has a higher activation barrier (ΔG^{‡}_{10 0}=23.41 kcal/mol) via TS-15c, which is in line with slight or no carbon dioxide being seen during the reaction. Lastly, the Ru—H intermediate goes through σ-bond metathesis to regeneration to give back Ru-methoxide species 7c via TS-19c, which is uphill (ΔG₁₀₀=3.10 kcal/mol) by a barrier of 18.63 kcal/mol. The further dehydrogenation of formic acid leads to the intermediate 16c via TS-15c (ΔG‡₁₀₀=23.41 kcal/mol) in a downhill reaction (ΔG₁₀₀=−1.92 kcal/mol). Then, the formation of carbon dioxide 16c→TS-17c→18c is downhill (ΔG₁₀₀=−14.75 kcal/mol) with a barrier of 18.08 kcal/mol.

### Example 1: Synthetic Procedure for NNN Pincer-Ruthenium Complexes

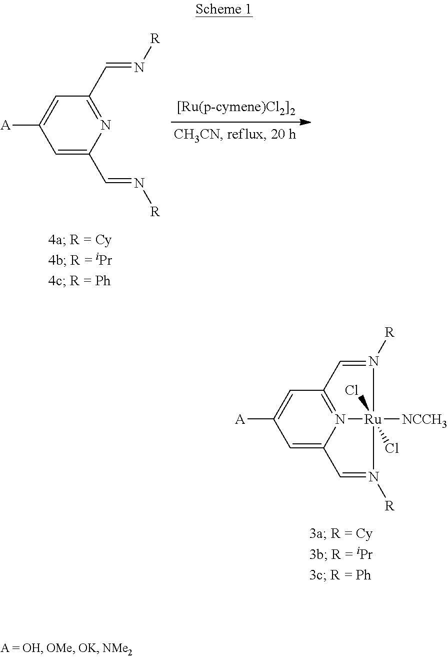

A series of new pincer-ruthenium complexes were prepared using [Ru(p-cymene)Cl₂]₂ with ^{R2}NNN ligand (R=^{t}Bu, ⁱPr, Cy, Ph) in presence of CH₃CN as solvent (Scheme 2), and all of these complexes were employed towards catalytic methanol reforming for generation of green hydrogen.

### Synthesis and Characterization of 3a-c

The NNN pincer-Ru complexes (3a-c) were obtained from the reaction of corresponding ligands (4a-c) with [Ru(p-cymene)Cl₂]₂ in acetonitrile under reflux conditions overnight (Scheme 2). Then it was washed with diethyl ether. The complexes 3a-c were completely characterized by HRMS, IR, ¹H and ¹³C NMR studies.

Further optimization of various pincer-ruthenium catalysts was carried out with MeOH and H₂O in 2:1 ratio using 50 mol % KO^{t}Bu (Table 2). The best catalytic activity among the carbonyl complexes (1a-f) was displayed by (^{Ph2}NNN)RuCl₂(CO) (1d) (Table 2, entry 4). Further, using the PPh₃ complexes 2a-f (Table 2, entries 7-12), highest yield (ca. 24%) was obtained with complex 2b (Table 2, entry 8). The corresponding acetonitrile complexes (3a-c) gave lower yields (Table 2, entries 13-15) in comparison to 2a-d. The commercially available ruthenium salts RuCl₃·3H₂O, RuCl₂(PPh₃)₃ and [Ru(p-cymene)Cl₂]₂ gave lesser yields than the pincer-ruthenium complexes (Table 2, Entries 16-18). Out of all the complexes screened, ^{Cy2}NNNRuCl₂(PPh₃) (2b) was the most reactive one (Table 2, Entry 8).

Further changes in reaction conditions (Table 3) were done with 0.04 mol % loading of 2b, 0.5 equivalent KO^{t}Bu and MeOH/H₂O (2:1). The impact of the temperature on the catalytic activity was also studied, with similar mmols of hydrogen being generated at 120° C. and 140° C. (Table 3, entries 1-3). Notably, improvement in yields were observed when the base loading was increased to 1 equivalent (ca. 43%) and further to 1.5 equivalents of KO^{t}Bu (ca. 66%) (Table 3, entries 4-5). The further increase in base loading was not done due to the poor solubility of KO^{t}Bu at higher concentrations. There was an increase in yield of hydrogen, when the catalyst loading was increased (Table 3, entries 6-9). There was hardly any increment in yield when the reaction was performed at 2 mol % of 2b (Table 3, entry 10). The liberation of hydrogen from methanol and water was studied at higher amounts of methanol, and good yields of hydrogen along with very high yield of formic acid was achieved at 3 equivalents of methanol (Table 3, entry 11) under 0.8 mol % loading of 2b. The lesser amounts of gas were evolved when the reaction mixture was further diluted at 4:1 MeOH/H₂O (Table 3, entry 12). Lesser yields were seen in case of neat methanol (Table 3, entry 13) and no reaction was observed when only water was used as reactant (Table 3, entry 14).

TABLE 1
Variation of additives/base in methanol reforming with 1b^{a}

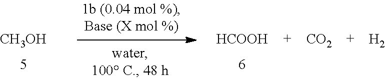

| | | Volume | | | | | | |
|---|---|---|---|---|---|---|---|---|
| | | of gas | Volume | | | | | Yield |
| | Base | evolved in | of gas | | mmols | Yield | Yield of | of |
| | (X | absence of | evolved | mmols | of | of H^{b} | HCOOH^{c} | CO₂^{e} |
| Entry | equivalents) | catalyst (mL) | (mL) | of H₂ | CO₂^{d} | (%) | (%) | (%) |
| 1 | NaOH (1) | 9 | 26 | 1 | 0 | 2 | 2 | 0 |
| 2 | NaO^{t}Bu (1) | 12 | 15 | 0.1 | 0 | 1 | 1 | 0 |
| 3 | KO^{t}Bu (1) | 10 | 20 | 0.4 | 0.1 | 3^{f} | 2 | 1 |
| 4 | NaOEt (1) | 17 | 22 | 0.2 | 0 | 3 | 3 | 0 |
| 5 | Na₂CO₃ (1) | 17 | 18 | 0.04 | 0 | 0.4 | 0.4 | 0 |
| 6 | K₂CO₃ (1) | 12 | 13 | 0.1 | 0 | 0.6 | 0.6 | 0 |
| 7 | KOH (1) | 10 | 11 | 0.03 | 0 | 0.3 | 0.3 | 0 |
| 8 | NaO^{t}Bu (0.2) | 11 | 15 | 0.2 | 0 | 2 | 2 | 0 |
| 9 | KO^{t}Bu (0.5) | 12 | 19 | 0.3 | 0 | 3 | 3 | 0 |
| 10 | KO^{t}Bu (0.2) | 12 | 15 | 0.1 | 0 | 1 | 1 | 0 |
| 11 | KO^{t}Bu (0.1) | 13 | 14 | 0.04 | 0 | 0.1 | 0.1 | 0 |

^{a}Reaction condition: Methanol (0.375 ml, 9.27 mmol), H₂O (0.083 ml, 4.635 mmol), base (X mol %), 1b (0.04 mol %) at 100° C. Gas evolution was determined by burette measurements.
^{b}Yield was calculated as n(H₂)/n(H₂O); (n(H₂) was calculated using ideal gas equation).
^{c}The yield of formic acid is calculated by ¹H NMR spectroscopy using sodium acetate as an internal standard.
^{d,e}The amount of carbon dioxide formed in the reaction was calculated taking in account the subsequent dehydrogenation of HCOOH to H₂ and CO₂; n(CO₂) = (mmol of gas − 2 * mmol of formic acid)/4; yield of CO₂ = n(CO₂)/n(H₂O).
^{f}Calculated as weighted average of % hydrogen generated from formic acid and % hydrogen generated from CO₂.

TABLE 2
Variation of pincer-ruthenium catalysts for methanol reforming^{a}

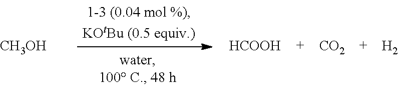

| | | Volume | | | | | | |
|---|---|---|---|---|---|---|---|---|
| | | of gas | | | | | | |
| | | evolved in | Volume | | | | | |
| | | absence of | of gas | | mmols | Yield | Yield of | Yield of |
| | | catalyst | evolved | mmols | of | of H₂^{b} | HCOOH^{c} | CO₂^{e} |
| Entry | Catalyst | (mL) | (mL) | of gas | CO₂^{d} | (%) | (%) | (%) |
| 1 | 1a | 12 | 14.0 | 0.1 | 0 | 1 | 1 | 0 |
| 2 | 1b | 12 | 19 | 0.3 | 0 | 3 | 3 | 0 |
| 3 | 1c | 12 | 14 | 0.1 | 0 | 1 | 1 | 0 |
| 4 | 1d | 12 | 43 | 1 | 0 | 14 | 14 | 0 |
| 5 | 1e | 12 | 13 | 0.1 | 0 | 1 | 1 | 0 |
| 6 | 1f | 12 | 32 | 1 | 0 | 9 | 9 | 0 |
| 7 | 2a | 12 | 18 | 0.2 | 0 | 3 | 3 | 0 |
| 8 | 2b | 12 | 65 | 2 | 0 | 24 | 24 | 0 |
| 9 | 2c | 12 | 29 | 1 | 0 | 8 | 8 | 0 |
| 10 | 2d | 12 | 59 | 2 | 0 | 21 | 21 | 0 |
| 11 | 2e | 12 | 29 | 1 | 0 | 8 | 8 | 0 |
| 12 | 2f | 12 | 42 | 1 | 0 | 13 | 13 | 0 |
| 13 | 3a | 12 | 27 | 1 | 0 | 7 | 7 | 0 |
| 14 | 3b | 12 | 24 | 1 | 0 | 6 | 6 | 0 |
| 15 | 3c | 12 | 17 | 0.2 | 0 | 2 | 2 | 0 |
| 16 | RuCl₂(PPh₃)₃ | 12 | 18 | 0.2 | 0 | 3 | 3 | 0 |
| 17 | RuCl₃•3H₂O | 12 | 21 | 0.4 | 0.1 | 3 | 1 | 2 |
| 18 | [Ru(p-cymene) | 12 | 38 | 1 | 0 | 12 | 12 | 0 |
| | Cl₂]₂ | | | | | | | |

^{a}Reaction condition: Methanol (0.375 ml, 9.27 mmol), H₂O (0.083 ml, 4.635 mmol), base (X equiv.), [Ru] (0.04 mol %) at 100° C. Gas evolution was determined by burette measurements.
^{b}Yield was calculated as n(H₂)/n(H₂O); (n(H₂) was calculated using ideal gas equation).
^{c}The yield of formic acid is calculated by ¹H NMR spectroscopy using sodium acetate as an internal standard.
^{d,e}The amount of carbon dioxide formed in the reaction was calculated taking in account the subsequent dehydrogenation of HCOOH to H₂ and CO₂; n(CO₂) = (mmol of gas − 2 * mmol of formic acid)/4; yield of CO₂ = n(CO₂)/n(H₂O).
^{f}Calculated as weighted average of % hydrogen generated from formic acid and % hydrogen generated from CO₂.

TABLE 3
Catalytic methanol reforming by 2b^{a}

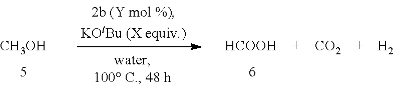

| | | | Volume | | | | | | |
|---|---|---|---|---|---|---|---|---|---|
| | | | of gas | | | | | | |
| | | | evolved in | Volume | | | | | |
| | | | absence of | of gas | | mmols | Yield | Yield of | Yield of |
| | 2b | KO^{t}Bu | catalyst | evolved | mmols | of | of H₂^{b} | HCOOH^{c} | CO₂^{e} |
| Entry | (mol %) | (equiv.) | (mL) | (mL) | of gas | CO₂^{d} | (%) | (%) | (%) |
| 1^{a} | 0.04 | 0.5 | 12 | 65 | 2 | 0 | 24 | 24 | 0 |
| 2^{a,f} | 0.04 | 0.5 | 15 | 68 | 2 | 0 | 23 | 23 | 0 |
| 3^{a,g} | 0.04 | 0.5 | 14 | 61 | 2 | 0 | 21 | 21 | 0 |
| 4^{a} | 0.04 | 1.0 | 10 | 107 | 4 | 0 | 43 | 43 | 0 |
| 5^{h} | 0.04 | 1.5 | 15 | 89 | 3 | 0 | 66 | 66 | 0 |
| 6^{h} | 0.1 | 1.5 | 15 | 93 | 3 | 0 | 69 | 69 | 0 |
| 7^{h} | 0.2 | 1.5 | 15 | 106 | 4 | 0 | 81ⁱ | 81 | 0 |
| 8^{h} | 0.4 | 1.5 | 15 | 137 | 5 | 1 | 82^{j} | 56 | 24 |
| 9^{h} | 0.8 | 1.5 | 15 | 144 | 5 | 1 | 89^{j} | 64 | 25 |
| 10^{h} | 2.0 | 1.5 | 15 | 137 | 5 | 0.4 | 90^{j} | 73 | 18 |
| 11^{k} | 0.8 | 1.5 | 5 | 105 | 4 | 0.1 | 89^{j} | 86^{o} | 4 |
| 12^{l} | 0.8 | 1.5 | 9 | 123 | 3 | 1 | 51 | 1 | 50 |
| 13^{m} | 0.8 | 0.75 | 12 | 96 | 3 | 0.4 | 29 | 21 | 8 |
| 14ⁿ | 0.8 | 0.75 | 17 | 17 | 0 | 0 | 0 | 0 | 0 |

^{a}Reaction condition: Methanol (0.375 ml, 9.27 mmol), H₂O (0.083 ml, 4.635 mmol), base (X mol %), 2b (Y mol %) at 100° C. Gas evolution was determined by burette measurements.
^{b}Yield was calculated as n(H₂)/n(H₂O); (n(H₂) was calculated using ideal gas equation).
^{c}The yield of formic acid is calculated by ¹H NMR spectroscopy using sodium acetate as an internal standard.
^{d,e}The amount of carbon dioxide formed in the reaction was calculated taking in account the subsequent dehydrogenation of HCOOH to H₂ and CO₂; n(CO₂) = (mmol of gas − 2 * mmol of formic acid)/4; yield of CO₂ = n(CO₂)/n(H₂O).
^{f}The reaction was performed at 120° C.
^{g}The reaction was performed at 140° C.
^{h}Reaction condition: Methanol (0.188 ml, 4.64 mmol), H₂O (0.042 ml, 2.32 mmol), base (X mol %), 2b (Y mol %) at 100° C.
ⁱThis corresponds to 3.8 mmol of hydrogen which was further confirmed by obtaining 3.8 mmol of ethyl benzene starting from 4 mmol of styrene in the presence of Pd/C at 120° C.
^{j}Calculated as weighted average of % hydrogen generated from formic acid and % hydrogen generated from CO₂.
^{k}6.95 mmol of MeOH, 2.32 mmol of H₂O, 3.48 mmol of KO^{t}Bu and 0.018 mmol of 2b was used. The reaction was stopped after 72 h.
^{l}19.27 mmol of MeOH, 2.32 mmol of H₂O, 3.48 mmol of KO^{t}Bu and 0.018 mmol of 2b was used.
^{m}Only MeOH (4.64) was used.
ⁿOnly water (4.64) was used.
^{o}Average of three runs.

The ³¹P NMR experiment was carried out with 2b (80 mM) complex in MeOH and H₂O (2:1). At first, ³¹P NMR of 2b in MeOH:H₂O (2:1) showed a single peak at 29.37 ppm which was observed due to the PPh₃ ligand present in the complex. After addition of KO^{t}Bu (0.5 equiv.), 3 peaks at −5.50 ppm, 30.89 and 38.65 ppm were observed. These peaks correspond to free PPh₃, Ph₃P═O and coordinated Ph₃P═O. Thus, it is evident that after addition of base, PPh₃ is dissociated from the complex, resulting in the formation of catalytically active pentacoordinate species. After heating the reaction mixture at 100° C., only the peak at 30.44 remained, which corresponded to Ph₃P═O, which was formed from the free PPh₃ released from the complex. This experimental study is in accordance to the preliminary formation of the pentacoordinate ^{Cy2}NNNRuCl₂ species (2c′), which takes part in the catalysis and is well supported by the HRMS analysis.

Further the control experiments were carried out as per the below scheme;

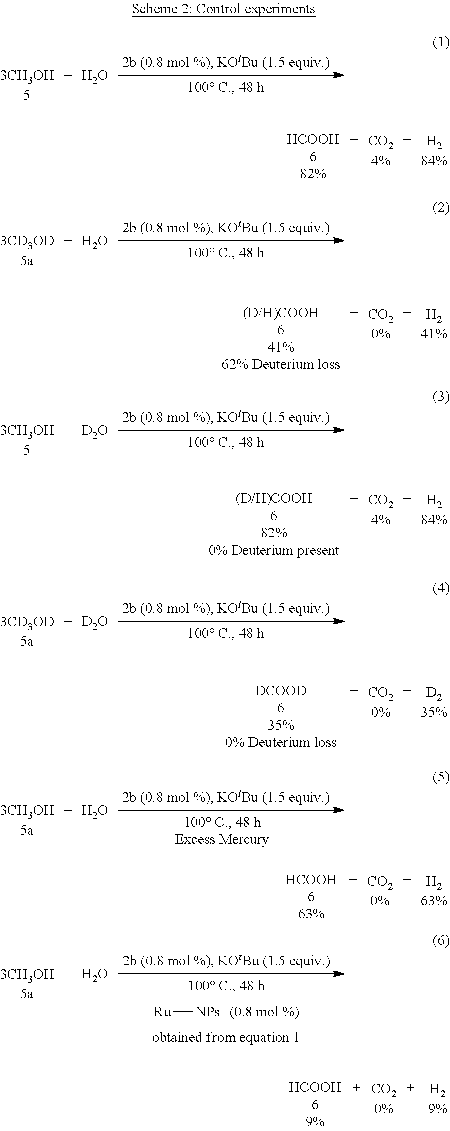

The KIE (Kinetic Isotope Effect) of 2.1 was obtained from taking the ratio of TOF (Turnover Frequency) of gas evolution (after 48 h) for 2b catalyzed reaction of CH₃OH (13.92 mmol) and CD₃OD (13.92 mmol) with water (4.64 mmol) (equation 1 vs equation 2, Scheme 2) in the presence of KO^{t}Bu (6.96 mmol) at 100° C. The deuterium incorporation was observed in case of CD₃OD and not D₂O (equation 2 vs equation 3, Scheme 2), which points to the influence of former in altering the rate of the reaction. The results obtained from the mercury drop test (equation 5, Scheme 2) and reaction with tiny amounts of black particles (equation 6, Scheme 2) formed in equation 1, Scheme 2 points to the homogeneous nature of the rection. The low yields of hydrogen in equation 6, Scheme 2 suggests that the formation of Ru nanoparticles is a deactivation step in 2b catalyzed methanol reforming reaction.

The above observations form the basis of the proposed mechanism (FIG. 1). The mechanism has been computationally studied, for which DFT calculations were performed using the PBEPBE method using the Def2SVP basis set with a polarization function. The first step involves the loss of PPh₃ from 2c to afford 16—electron pentacoordinate species consisting of two chloride ligands (2c′).²¹ The barrier for this transformation is computed to be 22.16 kcal/mol at 100° C. In the presence of methanol (5) and base, the dichloride species undergoes salt-metathesis to form Ru-methoxide species 7c.

### Example 2: Application

Further, on-site synthesis of D₂ and incorporation it to several unsaturated compounds was done in the context of labelling organic compounds with hydrogen isotopes, which find various applications in materials and medicinal chemistry, the present invention provides (Scheme 3).

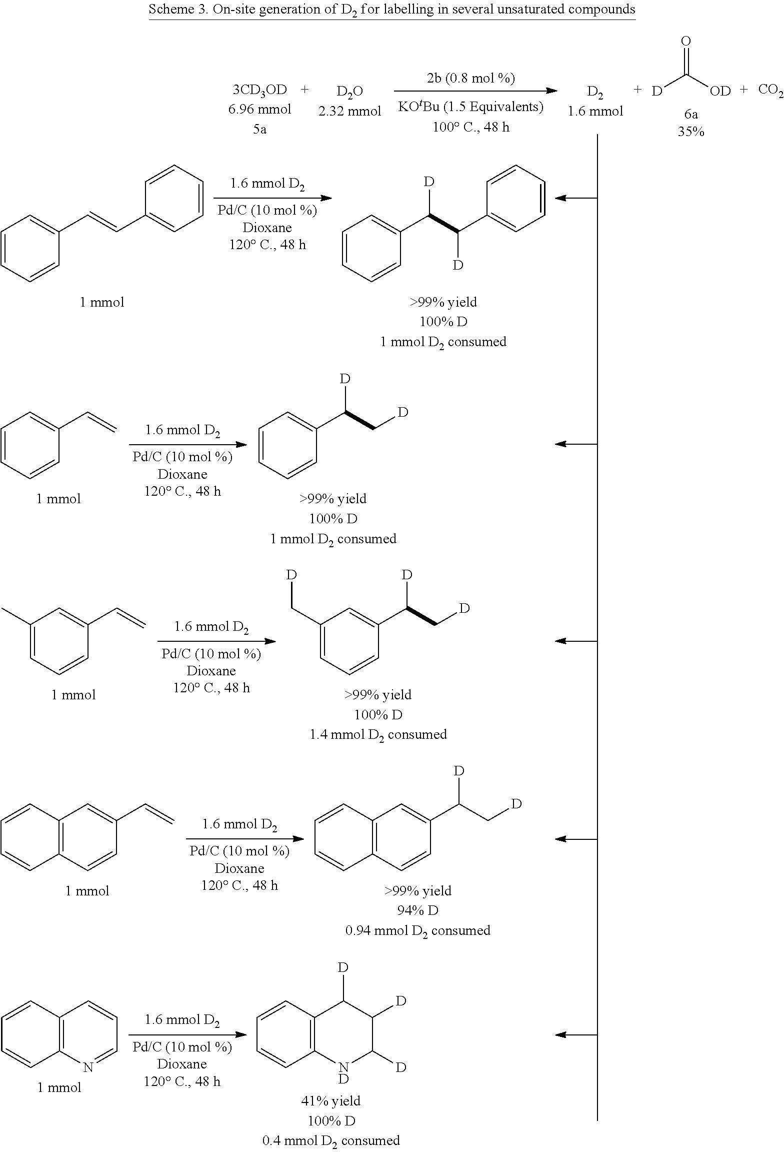

Therefore, the present invention provides the generation of green hydrogen gas as a source of clean energy from methanol in addition to quantitative yields of formic acid, catalyzed by a range of group (VIII) complexes based on a variety of ligands. Herein, methanol has been used as an efficient and practical hydrogen storage material and methanol reforming to green hydrogen and formic acid is achieved at ambient conditions. The commercially available ruthenium precursors RuCl₃·3H₂O, RuCl₂(PPh₃)₃ and [Ru(p-cymene) Cl₂]₂ gave lower conversion and TONs than the pincer-ruthenium and related group (VIII) complexes. Pincer based ruthenium complexes including the newly synthesized (^{R2}NNN)RuCl₂(CH₃CN) were studied for the methanol reforming reaction. The complex (^{Cy2}NNN)RuCl₂(PPh₃) was found to be the most active among the considered complexes. In case of MeOH/H₂O (2:1), 0.2 mol % of (^{Cy2}NNN)RuCl₂(PPh₃) and 1.5 equivalents of K^{t}BuO (w.r.t water), 81% yield of hydrogen and formic acid were observed with 100% selectivity at 100° C. after 48 h. Further, employing a 3:1 mixture of methanol and water under the catalyst loading of 0.8 mol % (^{Cy2}NNN)RuCl₂(PPh₃), resulted in 84% yield of H₂. In this case, formic acid was obtained with 82% yield and 95% selectivity.

The detailed mechanistic studies were performed which involved ³¹P NMR studies, deuterium incorporation, HRMS analysis and computational studies. The homogeneous nature of the reaction was confirmed by the mercury poisoning reaction. The somewhat low value of KIE (ca. 1.96) points towards the involvement of C—H activation in the mechanism but not as a part of RDS. This is very well complemented by the HRMS and DFT studies, which show that the σ-bond metathesis of the O—H bond of methanediol coordinated to the metal centre and Ru—H bond is the RDS with a barrier of 23.85 kcal/mol. The high selectivity of the current catalytic system towards formic acid and high yields of hydrogen at 100° C., paves the way for prospective development of aqueous methanol reforming reactions.

Many modifications and other embodiments of the invention set forth herein will readily occur to one skilled in the art to which the invention pertain having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

We claim:

1. A pincer group (VIII) complex catalyst for generation of green hydrogen from methanol reforming, having general formula I: 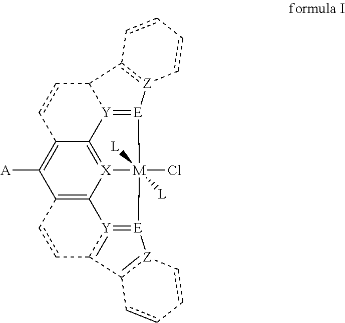
wherein,
M is selected from group VIII elements including iron (Fe), ruthenium (Ru), osmium (Os) and hassium (Hs);
X is selected from carbon, nitrogen or oxygen;
E is nitrogen, oxygen, phosphorus or arsenic;
A is selected from hydrogen or hydroxide or alkoxide;
L is selected from chlorine or triphenylphosphine;
Y is selected from methylene, oxygen, amine group or sulphur;
Z is selected from alky or aryl group; and
wherein said catalyst generates 2 molecules of hydrogen and 1 molecule of formic acid per catalytic reaction.

2. The pincer group (VIII) complex catalyst as claimed in claim 1, wherein said catalyst is synthesized from:
a) Dichloro(p-cymene)ruthenium(II) dimer;
b) Acetonitrile; and
c) ^{R2}NNN ligand
wherein R is selected from the group of tertiary butyl, isopropyl, cyclohexyl or phenyl.

3. A process for the generation of green hydrogen from methanol reforming catalysed by pincer group (VIII) complex catalyst comprising the steps of:
a) reacting a catalyst with a base in a reaction vessel to obtain a first reaction mixture;
b) adding 2 equivalent of methanol and 1 equivalent of water to the first reaction mixture of step (a) to obtain a second reaction mixture;
c) heating the second reaction mixture obtained in step (b) at a temperature ranging from 100-120° C. for a time period of 36-48 hours and measuring the gas evolution; and
wherein said process generates 2 molecules of hydrogen and 1 molecule of formic acid per catalytic reaction.

4. The process as claimed in claim 3, wherein the amount of the catalyst utilized in step (a) ranges from 0.04-2 mol %.

5. The process as claimed in claim 3, wherein the amount of base is in the range of 0.5 to 2 equivalent.

6. The process as claimed in claim 3, wherein the base is selected from potassium hydroxide, sodium hydroxide, sodium tertiary butoxide, potassium tertiary butoxide, sodium ethoxide, sodium carbonate and potassium carbonate.

7. The process as claimed in claim 3, wherein the yield of hydrogen is between 81-84% with 100% selectivity and yield of formic acid is 82% with 95% selectivity.

8. The process as claimed in claim 3, wherein the catalyst is selected from: 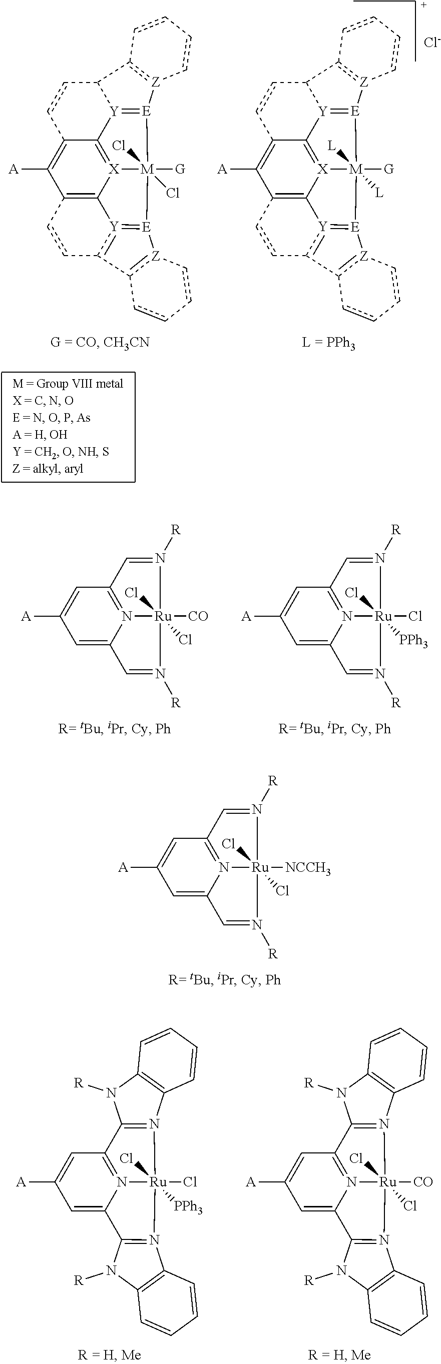 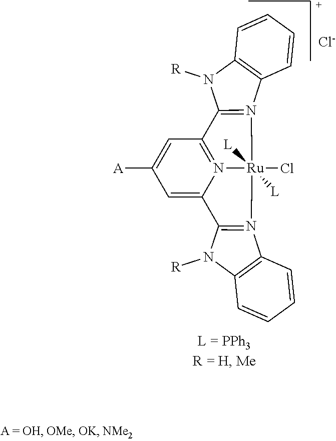
wherein,
R is selected from the group of tertiary butyl, isopropyl, cyclohexyl, hydrogen, methyl or phenyl; and
L is selected from chlorine or triphenylphosphine.
